(19) United States
(12) Patent Application Publication
(10) Pub. No.: US 2026/0298760 A1
(43) Pub. Date: Oct. 1, 2026

(54) CONNECTION DEVICE FOR A TEST LEAK DEVICE

(71) Applicant: INFICON GMBH, Köin (DE)

(72) Inventors: Yessica BRACHTHÄUSER, Köin (DE); Maximilian REISMANN, Köin (DE); Daniel WETZIG, Köin (DE)

(73) Assignee: INFICON GMBH, Köin (DE)

(21) Appl. No.: 19/480,644

(22) PCT Filed: Apr. 22, 2024
(86) PCT No.: PCT/EP2024/060905

§ 371 Date: Oct. 31, 2025

(30) Foreign Application Priority Data
May 9, 2023 (DE) 10 2023 112 051.4

(51) Int. Cl. G01M 3/04

(52) U.S. Cl. CPC G01M 3/04

(57) ABSTRACT

A connection device can connect a test leak device to a gas leak detection device to verify that the gas leak detection device is functioning properly or to calibrate it. The test leak device has an interior for holding a test fluid that is surrounded by a test leak housing, and a test leak opening that connects the interior to the external surroundings. The gas leak detection device can detect gas exiting from a device during a test. The connection device has a first and a second connection point for the test leak device, and a connection channel that connects the first and second connection points. The first connection point is provided with a carrier gas supply line so that test fluid exiting from the test leak opening is transported through the connection channel to the second connection point by carrier gas supplied via the carrier gas supply line.

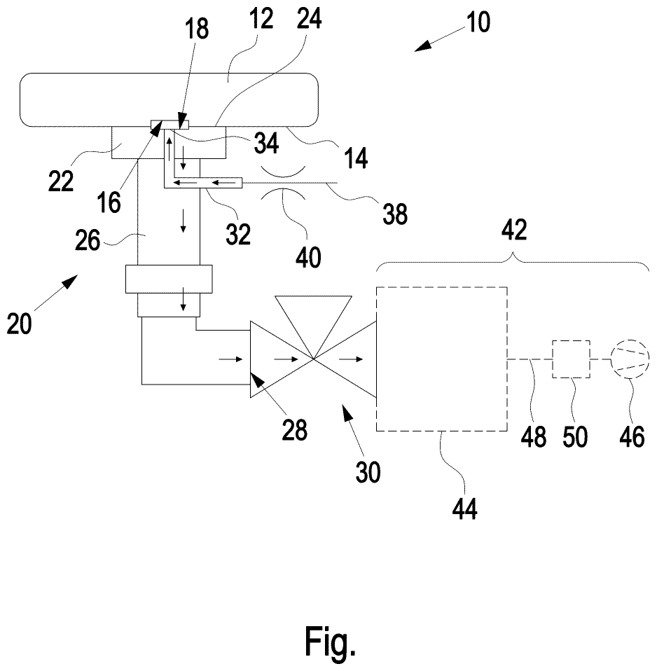

### CROSS-REFERENCE TO RELATED APPLICATIONS

This application is a national stage application filed under 35 U.S.C. § 371 of International Application No. PCT/EP2024/060905, filed on Apr. 22, 2024, which claims priority to German Application No. DE 10 2023 112 051.4, filed on May 9, 2023, the entire disclosures of which are incorporated herein by reference.

### BACKGROUND OF THE DISCLOSURE

### 1. Field of the Disclosure

The disclosure relates to a connection device for connecting a test leak device to a gas leak detection device.

### 2. Description of Related Art

Gas leak detection devices typically comprise an evacuable test chamber into which a test object filled with gas or liquid is placed. The test chamber has a gas analysis device—hereinafter also referred to as a gas detector—connected thereto, which analyzes the gas drawn from the test chamber to detect possible leakage gas that has escaped into the test chamber through a leak in the test object or to detect a liquid that escapes through the leak and evaporates. Here, it is of particular importance to be able to infer the size of the leak from the amount of the leakage gas detected. For this purpose, test leak devices are used which contain a predefined amount of a known test gas or test fluid and are provided with a leak having known dimensions and/or a known permeability to the fluid contained. Test leak devices are typically used to test the functionality of a gas leak detection device and to calibrate the gas leak detection device.

Such a test leak device is described, for example, in WO 2021/259579 A1. The test leak device has a test leak housing enclosing an interior space, the interior space accommodating a test fluid and being connected to the exterior of the test leak housing through a test leak opening in the test leak housing. The test leak opening can, for example, be closed by a membrane that is permeable to the test fluid. The test fluid can be a gas or a liquid. In particular, the test leak opening can be formed at the bottom of the test leak device so that the test fluid escapes downwards through the test leak opening due to the effect of gravity.

Conventionally, such test leak devices of the type described above are typically inserted into the test chamber of a gas leak detection device, wherein test fluid escaping from the test leak is fed directly into the test chamber and from there to the gas detector. In principle, however, it is also known to connect test leak devices to a gas leak detection device via a connection device so that test fluid escaping from the test leak device enters the test chamber through the connection device.

### SUMMARY OF THE DISCLOSURE

The disclosure is based on the task of providing an improved connection device for connecting a test leak device to a gas leak detection device and an associated method.

The connection device according to the disclosure has a connection channel surrounded by a channel wall, which connects a first connection point for the test leak device to a second connection point for the gas leak detection device. The special feature of the disclosure is that a carrier gas supply line opens in the area of the first connection point in such a way that carrier gas flows from the carrier gas supply line into the area of the first connection point and test fluid, which has escaped from the test leak device, is transported from the first connection point through the second connection into the gas leak detection device in order to be detected there by its gas detector. The carrier gas supply line can alternatively or additionally be used to supply a purge gas in order to purge the connection area for the test leak device and the downstream gas-carrying components of the connection device and the gas leak detection device with a purge gas. For the sake of simplicity, such a purge gas is also referred to here as a carrier gas.

The test leak device generally has a test leak housing which encloses an interior for the test fluid and has a test leak opening through which test fluid escapes from the interior. The test leak opening can be sealed with a membrane that is permeable to the test fluid. The test leak opening is preferably formed in a bottom of the test leak device or the test leak housing, as described, for example, in WO 2021/259579 A1. The gas leak detection device typically has a test chamber for holding a test object to be tested or a connection for the test object to be tested, whereby the test chamber or the connection is evacuated by a vacuum pump, and the evacuated gas from the test chamber or the test object is analyzed by a gas detector.

In other words, the special feature of the disclosure is that a carrier gas process is used to transport test fluid escaping from the test leak device to the gas detector.

Conventional carrier gas methods are used to flush a test chamber in order to transport leak gas escaping from a test object into the test chamber to the gas detector. According to the disclosure, however, the carrier gas is used to flush a connection device for a test leak device, but without flushing around the entire test leak device, in order to transport test fluid escaping from the test leak opening into the connection area through the connection channel to the gas leak detection device and to its gas detector.

In the method according to the disclosure, the test leak device is connected to the first connection point, while the second connection point is connected to the gas leak detection device. The second connection point is evacuated, preferably with the aid of the vacuum pump of the gas leak detector, which can also evacuate a test chamber of the gas leak detector or a connection point for the test object, for example. A carrier gas is supplied to the first connection point through the carrier gas supply line. With the supplied carrier gas, test fluid escaping from the test leak device is transported through the connection channel into the gas leak detection device and detected by its gas detector.

Advantageously, the first connection point of the connection device in the state connected to the gas leak detection device is designed to protrude upwards in such a way that the test leak device can be placed on the first connection point. A fluid-tight connection can be created between the connection device and the test leak device by evacuating the second connection point. The vacuum generated in the connection channel draws the test leak device onto the first connection point, thereby creating a stable fluid-tight connection between the test leak device and the connection device. Separate mechanical connections or locking elements are then not required or can be simplified.

Advantageously, the test leak device and, in particular, an area of the test leak device surrounding the test leak opening and the first connection point are designed to complement each other in order to create a form-fit connection between the test leak device and the first connection point.

The carrier gas supply line is preferably routed through the channel wall of the connection channel into the interior of the connection channel and has a carrier gas outlet in the area of the first connection within the connection channel. A carrier gas connection end of the carrier gas supply line opposite the carrier gas outlet is designed for connecting a carrier gas source, such as a gas storage container.

The carrier gas supply line is preferably equipped with a carrier gas shut-off valve, which can be opened and closed selectively. When closed, the carrier gas shut-off valve closes the carrier gas supply line so that no gas can pass from the carrier gas connection end to the carrier gas outlet. The carrier gas supply line can be provided with an adjustable flow throttle that specifies a suitable carrier gas flow or is designed to selectively adjust a suitable carrier gas flow.

The connection device according to the disclosure advantageously has a connection valve for connection to the gas leak detection device at the second connection point. The connection valve can be opened and closed selectively. The second connection point can, for example, be designed to be connected to a test chamber or the gas detector of the gas leak detection device.

The conventional carrier gas method is described in EP 1 522 838 B1, for example.

With the aid of the connection device according to the disclosure, carrier gas is not supplied to a test chamber in order to transport leakage gas escaping from a test object to the gas detector. Rather, the carrier gas is supplied into the connection area of a test leak in order to transport test fluid escaping from the test leak directly into the connection device through the connection device and supply it to the gas leak detection device. When the carrier gas is supplied to the gas leak detection device, it is already used to transport the test fluid, whereas in the known carrier gas methods, the leakage gas to be transported is intended to be absorbed only in the test chamber of a gas leak detection device.

The disclosure thus makes it possible to check and/or calibrate gas leak detection devices with the aid of test leak devices, in which the test leak device does not necessarily have to fit into the test chamber of the gas leak detection device. Rather, the test leak device can be connected to the first connection point of the connection device outside the gas leak detection device, independently of the test chamber. In one embodiment, this is done by simply placing the test leak device on the first connection point.

When the test leak device is connected to the connection device, the housing wall of the test leak housing is part of the outer wall of the vacuum system, which is formed by the gas leak detection device with its vacuum pump, the connection device, and the test leak device. This means that the vacuum pressure generated by the vacuum pump of the gas leak detector is applied directly at the test leak opening of the test leak detector due to the fluid-tight connection between the test leak housing and the connection channel. The test leak device is not surrounded by another outer wall of the vacuum system, such as a test chamber. With the aid of the carrier gas, test fluid escaping from the test leak opening can be diverted away from the connection area of the first connection point if the test fluid is not to be supplied to the gas leak detection device. For this purpose, an additional outlet of the connection valve at the second connection point or a separate flush valve of the connection device can be provided, for example.

### BRIEF DESCRIPTION OF THE DRAWING

The sole FIGURE shows a schematic representation of a combination of a test leak device and a connection device with a leak detection device illustrated in dashed lines.

### DETAILED DESCRIPTION OF THE DISCLOSURE

In the following, an exemplary embodiment of the disclosure is explained in detail with reference to the FIGURE. The FIGURE shows a schematic representation of a combination of a test leak device and a connection device with a leak detection device illustrated in dashed lines.

The test leak device 10 has a flat test leak housing 12, which encloses an interior with test fluid in the form of dimethyl carbonate. A test leak opening 16 is provided in a bottom surface 14 of the test leak housing 12, which connects the interior with its outer environment. A membrane that is selectively permeable to the test fluid is formed in the test leak opening 16. The test leak device 10 is connected to the first connection point 18 of a connection device 20 in a vacuum-tight and fluid-tight manner. For this purpose, the test leak device 10 is placed on an upwardly projecting connection flange 22. The connection flange 22 has a flat support surface 24 surrounding the first connection point 18 on the outside, which makes gas-tight contact with the bottom 14. For this purpose, the connection flange 22 can have a sealing ring, not shown in the FIGURE, which surrounds the first connection point 18 on the outside.

The connection device 20 has a tubular connection channel 26, at one end of which the first connection point 18 is formed, and the other end of which has a second connection point 28 for a gas leak detection device not shown in the FIGURE. The second connection point 28 has a connection valve 30 in the form of a 3-2-way valve. A first connection point of the connection valve 30 is connected to the second connection point 28 of the connection device 20. A second connection point of the connection valve 30 is connected to the gas leak detection device, for example, to a complementary connection point of a test chamber of the gas leak detection device. A third connection point of the connection valve 30 is open to the atmosphere and is used to purge the connection area of the first connection point 18 with carrier gas if this is not to be supplied to the gas leak detection device via the second connection point of the connection valve 30.

A carrier gas supply line 32 is led from the outside into the interior of the connection channel 26 and opens with a carrier gas outlet 34 within the connection channel 26 and within the connection flange 22 in the region of the first connection point 18. The carrier gas outlet 34 is arranged concentrically within the connection channel 26 and within the first connection point 18 and points directly to the test gas opening 16. The end of the carrier gas supply line 32 opposite the carrier gas outlet 34 forms a carrier gas connection end 38 outside the connection channel 26 for connecting a carrier gas source.

The carrier gas supply line 32 has a carrier gas shut-off valve, not shown in the FIGURE, for selectively opening or shutting off the carrier gas supply line 32. In addition, the carrier gas supply line 32 is provided with an adjustable flow throttle 40 for setting a suitable carrier gas flow.

The gas leak detection device 42 is shown in dashed lines in the FIGURE to make it clear that it is not part of the disclosure. Accordingly, the connection valve 30 is connected directly to a test chamber 44 for holding a test object. The test chamber 44 is vacuum-connected to a vacuum pump 46 for evacuating the test chamber 44. The test chamber 44 and the vacuum pump 46 are connected to each other by a vacuum line 48. The vacuum line 48 contains a gas detector 50 for analyzing the gas extracted from the test chamber 44. When the connection valve 30 is open, the vacuum pump 46 evacuates the connection device 20. The vacuum resulting from the connection channel 26 draws the test leak device 10 to the first connection point 18, creating a vacuum-tight, stable connection between the test leak housing 12 and the connection flange 22.

A carrier gas source, which is not shown in the FIGURE, can be connected to the carrier gas connection end 38, which can also serve as a carrier gas source for the test chamber 44. For this purpose, there can be a direct connection between the carrier gas source and the test chamber 44, which is separate and independent of the carrier gas supply line 32.

1. A connection device for connecting a test leak device to a gas leak detection device in order to check the functionality of the gas leak detection device or to calibrate the gas leak detection device, wherein the test leak device comprises an interior for holding a test fluid, wherein the interior is surrounded by a test leak housing, and a test leak opening that connects the interior to the external surroundings, and wherein the gas leak detection device is designed to detect gas escaping from a test object, the connection device comprising:
a first connection point for the test leak device;
a second connection point for the gas leak detection device;
a connection channel that connects the first connection point to the second connection point,
wherein the first connection point is provided with a carrier gas supply line so that test fluid escaping from the test leak opening is transported through the connection channel to the second connection point by carrier gas supplied via the carrier gas supply line.

2. The connection device according to claim 1, wherein when the connection device is mounted on the gas leak detection device, the first connection point protrudes upwardly so that a fluid-tight connection is formed between the test leak device and the connection channel when the test leak device is placed on the first connection point.

3. The connection device according to claim 1, wherein the carrier gas supply line is guided through a channel wall of the connection channel into the interior thereof and forms a carrier gas outlet in a region of the first connection point.

4. The connection device according to claim 1, wherein the carrier gas supply line comprises a carrier gas outlet and a carrier gas connection end opposite the carrier gas outlet, wherein the carrier gas connection end is designed for connection to a carrier gas source.

5. The connection device according to claim 1, wherein the carrier gas supply line comprises a carrier gas shut-off valve for selectively closing the carrier gas supply line or an adjustable flow throttle for selectively adjusting a carrier gas flow in the carrier gas supply line.

6. The connection device according to claim 1, wherein the second connection point is provided with a connection valve for the gas leak detection device.

7. A combination comprising:
the connection device according to claim 1; and
the test leak device,
wherein the test leak device and the first connection point are designed to be complementary to one another so that a fluid-tight connection between the test leak device and the connection device is created by placing the test leak device on the first connection point.

8. A method for connecting a test leak device to a gas leak detection device using the connection device according to claim 1, wherein the test leak device comprises an interior space enclosed by a test leak housing for receiving a test fluid and a test leak opening connecting the interior space to an external environment, the method comprising the steps of:
connecting the test leak device to the first connection point;
connecting the second connection point to the gas leak detection device;
evacuating the second connection point by the gas leak detection device;
supplying carrier gas through the carrier gas supply line to the first connection point;
transporting test fluid escaping from the test leak opening with the carrier gas through the connection channel into the gas leak detection device; and
detecting the transported test fluid with a gas detector.

9. The method according to claim 8, wherein the test leak device is connected to the connection channel by placing the test leak device on the first connection point, and wherein the evacuating produces a fluid-tight connection.
